(19) United States
(12) Patent Application Publication
(10) Pub. No.: US 2014/0068269 A1
(43) Pub. Date: Mar. 6, 2014

(54) METHOD, APPARATUS, AND SYSTEM FOR INTERACTION BETWEEN WEB CLIENT AND SERVER

(71) Applicant: HUAWEI TECHNOLOGIES CO., LTD., Shenzhen (CN)

(72) Inventor: Wei ZHOU, Shenzhen (CN)

(73) Assignee: HUAWEI TECHNOLOGIES CO., LTD., Shenzhen (CN)

(21) Appl. No.: 14/078,981

(22) Filed: Nov. 13, 2013

Related U.S. Application Data
(63) Continuation of application No. PCT/CN2013/071102, filed on Jan. 30, 2013.

(30) Foreign Application Priority Data
Apr. 21, 2012 (CN) 201210118858.9

(51) Int. Cl. H04L 9/08

(52) U.S. Cl. CPC H04L 9/0825
USPC 713/171

(57) ABSTRACT

A method, an apparatus, and a system for interaction between a Web client and a server are provided. The method includes: sending a web page download request to the server; receiving a returned web page download response; parsing the web page download response, and extracting a scripting language program code from web page contents included in the web page download response; determining, when the scripting language program code is loaded in a script engine of the Web client, whether the loaded scripting language program code is a scripting language program code in ciphertext format, and if it is in ciphertext format, calling a decryption module first to perform decryption on the scripting language program code in ciphertext format, to obtain a scripting language program code in plaintext format, and then executing, by the script engine, the scripting language program code in plaintext format loaded in the script engine.

### CROSS-REFERENCE TO RELATED APPLICATION

This application is a continuation of International Application No. PCT/CN2013/071102, filed on Jan. 30, 2013 which claims priority to Chinese Patent Application No. 201210118858.9, filed on Apr. 21, 2012, both of which are hereby incorporated by reference in their entireties.

### TECHNICAL FIELD

Embodiments of the present invention relate to the field of computers, and in particular, to a method, an apparatus, and a system for interaction between a Web client and a server.

### BACKGROUND

Javascript, VBscript, or a flash script is a web page development scripting language widely applied to a Web client, and may independently run on a Web client of a user, but does not require the support of a server. With the development of a Web2.0 system application and an HTML5 technology, a web socket Websocket provided by the Javascript further makes a Web client and a server implement a full duplex communication function. Functions of the scripting language Javascript are becoming stronger and stronger, so some service logics originally running on a server side are increasingly deployed in a Web client and runs by using a scripting language program code, to reduce the load of a server, while at the same time, another problem is also brought about: security. In other words, the release of a client/server C/S mode that uses the Javascript, as one type of plaintext, as a service carrier has a risk.

After a web page including a scripting language (Javascript) program is downloaded to a Web client, a user, by a plug-in and so on, may view, and even modify a source code of the web page including a program code of a scripting language. Therefore, when being ported to a scripting language program, a service logic is to be exposed to the user that uses the Web client, this brings the risk of insecurity for an application program on the server side; therefore, it becomes one of problems urgently required to be solved for how to conceal the scripting language program code in the web page at present.

### SUMMARY

Embodiments of the present invention provide a method for interaction between a Web client and a server, a Web client, and a Web system, to effectively reduce the load of an application server side, and at the same time, to implement the higher confidentiality.

The embodiments of the present invention provide the following technical solutions.

An embodiment of the present invention provides a method for interaction between a Web client and a server, including:

sending a web page download request to the server;

receiving a web page download response that corresponds to the web page download request and is returned by the server, where, the web page download response includes web page contents, where the web page contents includes a scripting language program code;

parsing the web page download response, and extracting the scripting language program code from the web page contents included in the web page download response; and

determining, when the extracted scripting language program code is loaded in a script engine of the Web client, whether the scripting language program code loaded in the script engine of the Web client is a scripting language program code in ciphertext format, and if the scripting language program code is in ciphertext format, calling a decryption module first to perform decryption on the scripting language program code in ciphertext format, to obtain a scripting language program code in plaintext format, where, the scripting language program code in plaintext format is loaded in the script engine, and then executing, by the script engine, the scripting language program code in plaintext format loaded in the script engine.

Another embodiment of the present invention provides a Web client, including:

an interface module, configured to send a web page download request to a server; and receive a web page download response that corresponds to the web page download request and is returned by the server, where, the web page download response includes web page contents, where the web page contents include a scripting language program code;

a parsing engine, configured to parse the web page download response, and extract the scripting language program code from the web page contents included in the web page download response; and

a script engine, configured to determine, when the extracted scripting language program code is loaded in the script engine, whether the scripting language program code loaded in the script engine is a scripting language program code in ciphertext format, and if the scripting language program code is in ciphertext format, call a decryption module to perform decryption on the scripting language program code in ciphertext format, to obtain a scripting language program code in plaintext format, where, the scripting language program code in plaintext format is loaded in the script engine, and configured to execute the scripting language program code in plaintext format loaded in the script engine; and

the decryption module, configured to perform decryption on the scripting language program code in ciphertext format, to obtain the scripting language program code in plaintext format.

A further embodiment of the present invention provides a Web system, including: an application server and the Web client of the embodiment of the present invention, where the application server is configured to receive a web page download request sent by the Web client, and return a corresponding web page download response to the Web client, where, the web page download response includes web page contents, where the web page contents include a scripting language program code in ciphertext format, or, a scripting language program code in plaintext format.

It can be seen from the above that, in the embodiments of the present invention, a Web client sends a web page download request to a server; receives a web page download response returned by the server, where, the web page download response includes web page contents, where the web page contents include a scripting language program code; parses the web page download response, and extracts the scripting language program code from the web page contents included in the web page download response; determines, when the scripting language program code is loaded in a script engine of the Web client, whether the scripting language program code loaded in the script engine of the Web client is a scripting language program code in ciphertext format, and if the scripting language program code is in ciphertext format, calls a decryption module first to perform decryption on the scripting language program code in ciphertext format, to obtain a scripting language program code in plaintext format, and then the script engine executes the scripting language program code in plaintext format; therefore, the embodiments of the present invention ensure that a scripting language program code in the web page is transported in ciphertext format during a transport procedure from the server to the Web client, and moreover, after a web page including the scripting language program code in ciphertext is downloaded to the Web client, because a decryption procedure is performed on the scripting language program code in ciphertext in the decryption module and the scripting language program code in plaintext format that is obtained by decryption and loaded in the script engine is executed in the script engine, in this way, the decryption procedure of the scripting language program code in the web page and the execution procedure of the scripting language program code in plaintext format after decryption are invisible to a Web client user, achieving actually concealing a service logic of the scripting language program code in the web page from the Web client user, thereby effectively reducing the load of the application server side, and at the same time, implementing the higher confidentiality.

### BRIEF DESCRIPTION OF DRAWINGS

To describe the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and persons of ordinary skill in the art may still derive other drawings from the accompanying drawings without creative efforts.

FIG. 1 is a schematic flowchart of a method for interaction between a Web client and a server according to an embodiment of the present invention;

FIG. 2-A is a schematic flowchart of another method for interaction between a Web client and a server according to an embodiment of the present invention;

FIG. 2-B is a schematic flowchart of another method for interaction between a Web client and a server according to an embodiment of the present invention;

FIG. 3 is a schematic flowchart of another method for interaction between a Web client and a server according to an embodiment of the present invention;

FIG. 4 is a schematic flowchart of another method for interaction between a Web client and a server according to an embodiment of the present invention;

FIG. 5 is a schematic structural diagram of a Web client according to an embodiment of the present invention;

FIG. 6 is a schematic structural diagram of a Web system according to an embodiment of the present invention; and

FIG. 7 is a schematic structural diagram of another Web system according to an embodiment of the present invention.

### DESCRIPTION OF EMBODIMENTS

To make the solutions of the present invention more comprehensible for persons skilled in the art, the following clearly and completely describes the technical solutions in embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

The embodiments of the present invention provide a method, an apparatus, and a system for interaction between a Web client and an application server. A decryption module and a script engine are introduced inside the Web client, and after a Web client program downloads a web page, the Web client calls the script engine to execute a scripting language program code in the web page. The script engine, when loading the scripting language program code, determines whether the scripting language program code is in ciphertext format, and if the scripting language program code is in ciphertext format, calls the decryption module to decrypt the scripting language program code, to obtain a decrypted scripting language program in plaintext format, and directly loads the decrypted scripting language program code in plaintext format to the script engine for executing.

The embodiments of the present invention ensure that a scripting language program code in a web page is transported in ciphertext format during a transport procedure from an application server to a Web client, and moreover, after a web page including the scripting language program code in ciphertext is downloaded to the Web client, because a decryption procedure is performed on the scripting language program code in ciphertext in a decryption module and the scripting language program code in plaintext format that is obtained by decryption and loaded in a script engine is executed in the script engine, in this way, the decryption procedure of the scripting language program code in the web page and execution of the scripting language program code in the web page after decryption are invisible to a Web client user, achieving actually concealing a service logic of the scripting language program code in the web page from the Web client user, thereby effectively reducing the load of the application server, and at the same time, implementing the higher confidentiality, and moreover, to some extent, overcoming the following three problems, which are brought about by that, in the prior art, after the application server encrypts the scripting language program code included in the web page, the application server inserts a scripting language decryption method in plaintext format in a certain position in the web page, and then returns the web page to the Web client, and the Web client, after receiving the web page, calls, by using the script engine, the scripting language decryption method to decrypt the web page, to obtain a plaintext web page (correspondingly, a plaintext scripting program code included in the web page is obtained) and the script engine then runs the plaintext scripting program code in the web page: 1) The scripting language decryption method is inserted in the certain position in the web page in plaintext format, and then downloaded with the web page to the Web client; therefore, the entire decryption method and procedure are exposed to the Web client user. 2) After the web page is decrypted, the scripting language program code included in it is also delivered to the script engine in the Web client in plaintext format for compiling and running, and the Web client user can obtain the scripting language program code, and therefore can query a service logic code in it; and 3) The Web client user may further, with the assistance of tools, such as an editing plug-in, modify the scripting language program code, which brings about security risks to a Web application.

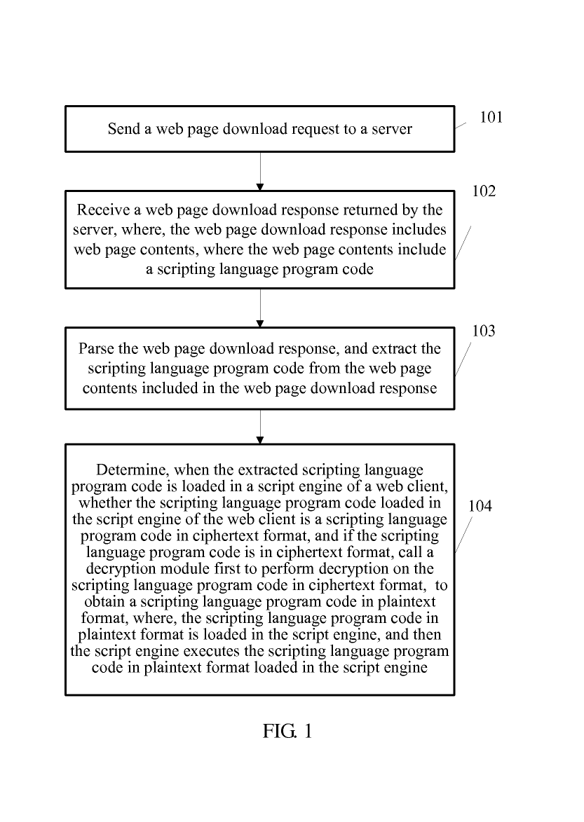

With reference to FIG. 1, it is a method for interaction between a Web client and a server that is provided by an embodiment of the present invention. It should be noted that, the executive subject of the method in the embodiment of the present invention may be a Web client, and it should be noted that, the Web client in the embodiment of the present invention may be understood as a Web program running environment or a running container, for example, may be a Web browser, a Web Widget running container, a Web application running container, and so on, which is not limited by the embodiment of the present invention. The method may include the following steps.

101. Send a web page download request to the server.

Specifically, the Web client sends the Web page download request to the server in encryption (such as https) or non-encryption (such as http) manner.

102. Receive a web page download response returned by the server, where, the web page download response includes web page contents, where the web page contents include a scripting language program code.

Specifically, the web page download response returned by the server in encryption (such as https) or non-encryption (such as http) manner is received.

It should be understood that, if the Web client and the server communicate with each other in encryption (such as https) manner, the confidentiality of a communication channel can be protected.

In addition, it should be understood that, the scripting language program code included in the web page contents may be a scripting language program code that reflects a service logic. For example, the scripting language program code is directly included in the web page, or a script file including the scripting language program code is included in the web page.

103. Parse the web page download response, and extract the scripting language program code from the web page contents included in the web page download response.

Specifically, the scripting language program code in the web page may be extracted according to the prior art, and is not described herein again.

The scripting language program code involved in the embodiment of the present invention includes but is not limited to: Javascript, VBScript, or a flash script, and so on.

104. A script engine determines, when the scripting language program code is loaded in the script engine of the Web client, whether the scripting language program code loaded in the script engine of the Web client is a scripting language program code in ciphertext format, and if the scripting language program code is in ciphertext format, the script engine calls a decryption module first to perform decryption on the scripting language program code in ciphertext format, to obtain a scripting language program code in plaintext format after decryption, and then executes the scripting language program code in plaintext format loaded in the script engine of the Web client.

If a symmetric encryption algorithm is used for encryption in the embodiment of the present invention, in an implementation manner, the method of the embodiment of the present invention may further include a step: calling the decryption module to generate, based on a predetermined key negotiation mechanism, a key.

Accordingly, step 101 specifically is: sending a web page download request to the server, where the key is carried in the web page download request.

Accordingly, the step of calling the decryption module to perform decryption on the scripting language program code in ciphertext format in step 104 is: calling the decryption module to perform, by using the generated key, decryption on the scripting language program code in ciphertext format, to obtain the scripting language program code in plaintext format.

Alternatively, if an asymmetric encryption algorithm is used for encryption in the embodiment of the present invention, in an implementation manner, the method of the embodiment of the present invention further includes a step: calling the decryption module to generate, based on a predetermined key negotiation mechanism, a key, where the key includes a public key and a private key.

Accordingly, step 101 specifically is: sending a web page download request carrying the public key to the server.

Accordingly, the step of calling the decryption module to perform decryption on the scripting language program code in ciphertext format in step 104 is: calling the decryption module to perform, by using the generated private key, decryption on the scripting language program code in ciphertext format, to obtain the scripting language program code in plaintext format.

In another implementation manner, if the server, after encrypting the scripting language program code by using a key, returns the web page download response, where the web page download response includes the web page contents (that is, a requested page) and the key, where the web page contents include the scripting language program code in ciphertext format, to the Web client, and accordingly, step 101 specifically is: receiving the web page download response returned by the server, where the web page download response further carries the key.

Accordingly, the step of calling the decryption module to perform decryption on the scripting language program code in ciphertext format in step 104 is: calling the decryption module to perform, by using the key or an Nth-generation key converted from the key, decryption on the scripting language program code in ciphertext format, to obtain the scripting language program code in plaintext format, where N is larger than or equal to 2.

It should be noted that, if N=2, a second-generation key herein is directly converted from a key carried by the web page download response; if N=3, a third-generation key herein is further converted from the foregoing second-generation key, and so forth, and it should be understood that, the embodiment of the present invention is not limited thereto.

It can be seen from the above that, this embodiment has the following beneficial effects:

1) good confidentiality: A scripting language program code in a web page, after being transmitted to a Web client after being encrypted on an application server side, is directly loaded in a script engine in the Web client, and by using a decryption module inside the Web client, decryption is performed on the scripting language program code loaded in the script engine of the Web client, and a scripting language program code in plaintext format after decryption is loaded in the script engine for execution, during an entire transmission procedure from a server to the Web client, the scripting language program code in the web page is transmitted in ciphertext format, moreover, after a web page including the scripting language program code in ciphertext is downloaded to the Web client, because a decryption procedure is performed on the scripting language program code in ciphertext in the decryption module and the scripting language program code in plaintext format that is obtained by decryption and loaded in the script engine is executed in the script engine, in this way, the decryption procedure of the scripting language program code in the web page and an execution procedure of the scripting language program code in plaintext format after decryption are invisible to a Web client user, implementing the confidentiality of a scripting language program in the web page during a transmission procedure and an entire procedure of decryption and running inside the Web client, thereby better protecting a scripting language program code that reflects a service logic, and eliminating the security risks of a Web application; and

2) reducing the load of an application server: Because the scripting language program code in the web page actually implements concealing from the Web client user, some service logics running on the application server side may be ported to the scripting language program and run on the Web client; therefore, the load of the application server side can be effectively reduced.

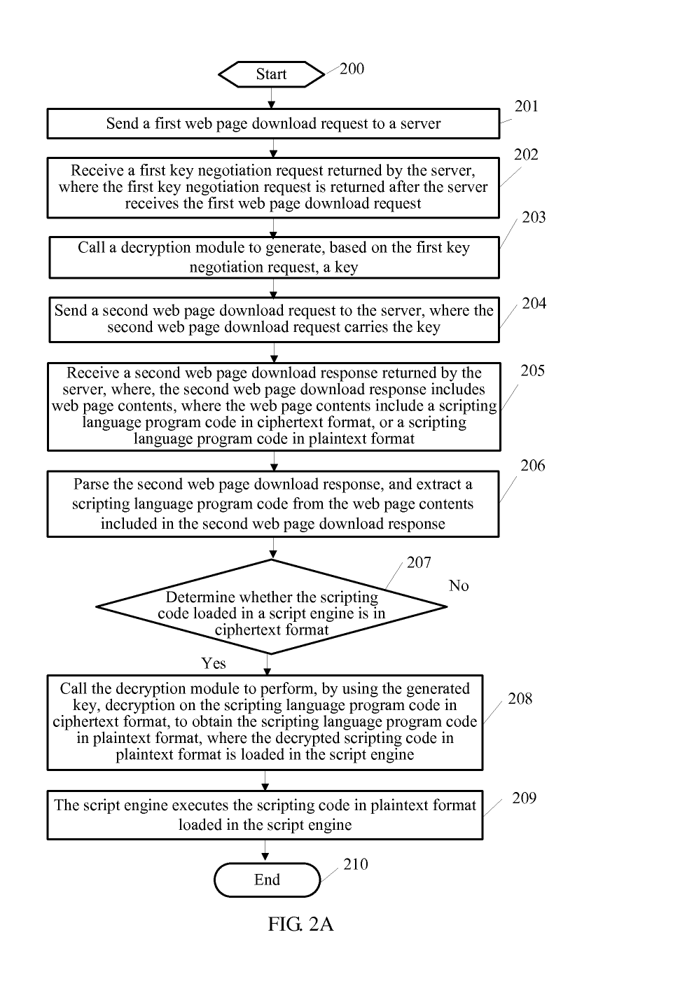

With reference to FIG. 2-A, it is another method for interaction between a Web client and a server that is provided by an embodiment of the present invention. It should be noted that, the executive subject of the method in the embodiment of the present invention may be a Web client, and it should be noted that, the Web client may be understood as a Web program running environment or a running container, for example, may be a Web browser, a Web Widget running container, a Web application running container, and so on, which is not limited by the embodiment of the present invention. The method may include the following steps.

200. Start.

201. Send a first web page download request to the server.

202. Receive a first key negotiation request returned by the server, where the first key negotiation request is returned after the server receives the first web page download request.

203. Call a decryption module to generate, based on the first key negotiation request, a key; and it should be noted that, a symmetric encryption algorithm may be used for encryption in this embodiment.

204. Send a second web page download request to the server, where the second web page download request carries the key.

205. Receive a second web page download response returned by the server, where, the second web page download response includes web page contents, where the web page contents include a scripting language program code in ciphertext format, or a scripting language program code in plaintext format.

It should be noted that, the web page contents included in the second web page download response herein may be encrypted web page contents, and also may be unencrypted web page contents, which are specifically implemented based on an actual application scenario or a demand.

It should be understood that, the server, based on a strategy, determines that which scripting language program codes in the web page contents need to be encrypted, and which scripting language program codes do not need to be encrypted. Alternatively, the server, based on a strategy, determines that a scripting language program code in which web page contents needs to be encrypted, and a scripting language program code in which web page contents does not need to be encrypted. The specific case is determined based on an actual application.

206. Parse the second web page download response, and extract a scripting language program code from the web page contents included in the second web page download response.

207. A script engine determines, when the extracted scripting language program code is loaded in the script engine of the Web client, whether the scripting language program code loaded in the script engine of the Web client is a scripting language program code in ciphertext format; and if the scripting language program code is in ciphertext format, execute step 208, or, if the scripting language program code is in plaintext format, execute step 209.

208. The script engine calls the decryption module first to perform, by using the key, decryption on the scripting language program code in ciphertext format, to obtain the scripting language program code in plaintext format after decryption, where, the scripting code in plaintext format after decryption is loaded in the script engine.

209. The script engine executes the scripting language program code loaded in the script engine in plaintext format.

It should be noted that, in step 207, the directly extracted scripting language program code is loaded in the script engine of the Web client, and in step 208, the scripting language program code in plaintext format after decryption is loaded in the script engine of the Web client.

210. End.

It can be seen from the above that, this embodiment has the following beneficial effects:

1) good confidentiality: A scripting language program code in a web page, after being transmitted to a Web client after being encrypted on an application server side, is directly loaded in a script engine in the Web client, and by using a decryption module inside the Web client, decryption is performed on the scripting language program code loaded in the script engine of the Web client, and a scripting language program code in plaintext format after decryption is loaded in the script engine for execution, during an entire transmission procedure from a server to the Web client, the scripting language program code in the web page is transmitted in ciphertext format, moreover, after a web page including the scripting language program code in ciphertext is downloaded to the Web client, because a decryption procedure is performed on the scripting language program code in ciphertext in the decryption module and the scripting language program code in plaintext format that is obtained by decryption and loaded in the script engine is executed in the script engine, in this way, the decryption procedure of the scripting language program code in the web page and an execution procedure of the scripting language program code in plaintext format after decryption are invisible to a Web client user, implementing the confidentiality of a scripting language program in the web page during a transmission procedure and an entire procedure of decryption and running inside the Web client, thereby better protecting a scripting language program code that reflects a service logic, and eliminating the security risks of a Web application; and

2) reducing the load of an application server: Because the scripting language program code in the web page actually implements concealing from the Web client user, some service logics running on the application server side may be ported to the scripting language program and run on the Web client; therefore, the load of the application server side can be effectively reduced.

With reference to FIG. 2-B, it is another method for interaction between a Web client and a server that is provided by an embodiment of the present invention. It should be noted that, the executive subject of the method in the embodiment of the present invention may be a Web client, and it should be noted that, the Web client may be understood as a Web program running environment or a running container, for example, may be a Web browser, a Web Widget running container, a Web application running container, and so on, which is not limited by the embodiment of the present invention. The method may include the following steps.

220. Start.

221. Send a third web page download request to the server.

222. Receive a third key negotiation request returned by the server, where the third key negotiation request is returned after the server receives the third web page download request.

223. Call a decryption module to generate a pair of keys based on the third key negotiation request, where the pair of keys includes of a public key and a private key.

It should be noted that, an asymmetric encryption algorithm may be used for encryption in this embodiment.

It should be understood that, encryption and decryption algorithms have many categories: symmetric and asymmetric, dynamic and static, and so on, but these encryption and decryption algorithms may all be applied to the embodiment of the present invention.

224. Send a fourth web page download request to the server, where the fourth web page download request carries the public key.

225. Receive a fourth web page download response returned by the server, where, the fourth web page download response includes web page contents, where the web page contents include a scripting language program code in ciphertext format, or a scripting language program code in plaintext format.

It should be understood that, the server, based on a strategy, determines that which scripting language program codes in the web page contents need to be encrypted, and which scripting language program codes do not need to be encrypted. Alternatively, the server, based on a strategy, determines that a scripting language program code in which web page contents needs to be encrypted, and a scripting language program code in which web page contents does not need to be encrypted. The specific case is determined based on an actual application.

226. Parse the fourth web page download response, and extract a scripting language program code from the web page contents included in the fourth web page download response.

227. A script engine determines, when the extracted scripting language program code is loaded in the script engine of the Web client, whether the scripting language program code loaded in the script engine of the Web client is a scripting language program code in ciphertext format; and if the scripting language program code is in ciphertext format, execute step 228, or, if the scripting language program code is in plaintext format, execute step 229.

228. The script engine calls the decryption module first to perform, by using the private key, decryption on the scripting language program code in ciphertext format, to obtain the scripting language program code in plaintext format after decryption, where, the scripting code in plaintext format after decryption is loaded in the script engine.

229. The script engine executes the scripting language program code in plaintext format loaded in the script engine.

It should be noted that, in step 227, the extracted scripting language program code is loaded in the script engine of the Web client, and in step 228, the scripting language program code in plaintext format after decryption is loaded in the script engine of the Web client.

230. End.

It can be seen from the above that, this embodiment has the following beneficial effects:

1) good confidentiality: A scripting language program code in a web page, after being transmitted to a Web client after being encrypted on an application server side, is directly loaded in a script engine in the Web client, and by using a decryption module inside the Web client, decryption is performed on the scripting language program code loaded in the script engine of the Web client, and a scripting language program code in plaintext format after decryption is loaded in the script engine for execution, during an entire transmission procedure from a server to the Web client, the scripting language program code in the web page is transmitted in ciphertext format, moreover, after a web page including the scripting language program code in ciphertext is downloaded to the Web client, because a decryption procedure is performed on the scripting language program code in ciphertext in the decryption module and the scripting language program code in plaintext format that is obtained by decryption and loaded in the script engine is executed in the script engine, in this way, the decryption procedure of the scripting language program code in the web page and an execution procedure of the scripting language program code in plaintext format after decryption are invisible to a Web client user, implementing the confidentiality of a scripting language program in the web page during a transmission procedure and an entire procedure of decryption and running inside the Web client, thereby better protecting a scripting language program code that reflects a service logic, and eliminating the security risks of a Web application; and

2) reducing the load of an application server: Because the scripting language program code in the web page actually implements concealing from the Web client user, some service logics running on the application server side may be ported to the scripting language program and run on the Web client; therefore, the load of the application server side can be effectively reduced.

To facilitate understanding, the following introduces a method of an embodiment of the present invention from the aspect of interaction between a Web client and an application server.

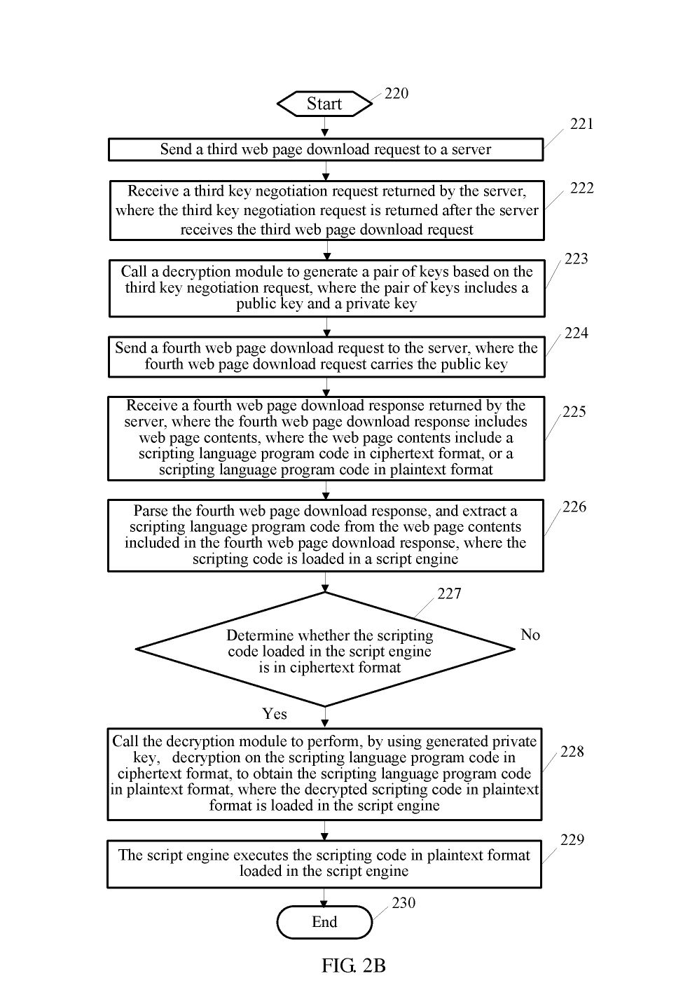

With reference to FIG. 3, it is a method for interaction between a Web client and an application server in an embodiment of the present invention. an asymmetric encryption algorithm is used for encryption in the embodiment of the present invention. The method may include the following steps.

301a-301b. In response to an operation of a user accessing a web page, the Web client (for example, an interface module) sends a web page download request to the application server, to request loading the web page.

302. The application server determines whether the requested web page needs to be encrypted, and if it is determined that the requested web page needs to be encrypted, returns a response to the Web client, to request providing a public key used for encryption.

303. After receiving the response, the interface module requests or calls a decryption module to generate a key.

304. The decryption module generates a pair of keys based on a key negotiation mechanism, which includes a public key and a private key.

It should be noted that, the public key and the private key are generated in a pair, and the public key is transmitted over the Internet, but the private key is managed by a generating party and a decrypting party, that is, the Web client, of the private key.

305. The decryption module provides the public key to the interface module.

306. The Web client (for example, the interface module) re-sends a web page download request to the application server, where the public key is carried in the re-sent web page download request.

307. The application server requests or calls an encryption module to perform encryption on a scripting language program code (the scripting language program code herein may be a scripting code directly included in the web page, or a scripting code included in a script file embedded in the web page, and is referred to as a scripting code hereinafter) in the requested web page.

308. The encryption module parses the web page, and extracts the scripting code in it.

309. The encryption module performs encryption on the extracted scripting code by using the public key.

310. The encryption module returns a web page including a scripting code in ciphertext format to the application server.

311. The application server returns the requested web page including the scripting code in ciphertext format to the Web client by using a web page download response.

312. The Web client (for example, the interface module) requests or calls a parsing engine to perform parsing on the web page.

313. The parsing engine parses the web page download response, and extracts the scripting code in the web page.

314. The parsing engine loads the scripting code in a script engine.

315. The script engine determines whether scripting code loaded in the script engine is a scripting code in ciphertext format or a scripting code in plaintext format, and if the scripting code loaded in the script engine is a scripting code in ciphertext format, go to step 316; or if scripting code loaded in the script engine is a scripting code in plaintext format, go to step 319.

316. The script engine requests or calls the decryption module to decrypt the scripting code in ciphertext format.

317. The decryption module performs decryption on the scripting code in ciphertext format by using the private key generated in step 303.

318. The decryption module loads the scripting code in plaintext format after decryption to the script engine.

319. The script engine executes the scripting code in plaintext format loaded in it.

320. The script engine returns an execution result of the scripting code to the interface module.

It should be understood that, optionally, the interface module displays the execution result of the scripting code to a user, and may further, in response to a further operation of the user on the execution result of the scripting code, initiate another web page download request to the application server.

It can be seen from the above that, this embodiment has the following beneficial effects:

1) good confidentiality: A scripting language program code in a web page, after being transmitted to a Web client after being encrypted on an application server side, is directly loaded in a script engine in the Web client, and by using a decryption module inside the Web client, decryption is performed on the scripting language program code loaded in the script engine of the Web client, and a scripting language program code in plaintext format after decryption is loaded in the script engine for execution, during an entire transmission procedure from a server to the Web client, the scripting language program code in the web page is transmitted in ciphertext format, moreover, after a web page including the scripting language program code in ciphertext is downloaded to the Web client, because a decryption procedure is performed on the scripting language program code in ciphertext in the decryption module and the scripting language program code in plaintext format that is obtained by decryption and loaded in the script engine is executed in the script engine, in this way, the decryption procedure of the scripting language program code in the web page and an execution procedure of the scripting language program code in plaintext format after decryption are invisible to a Web client user, implementing the confidentiality of a scripting language program in the web page during a transmission procedure and an entire procedure of decryption and running inside the Web client, thereby better protecting a scripting language program code that reflects a service logic, and eliminating the security risks of a Web application; and

2) reducing the load of an application server: Because the scripting language program code in the web page actually implements concealing from the Web client user, some service logics running on the application server side may be ported to the scripting language program and run on the Web client; therefore, the load of the application server side can be effectively reduced.

To facilitate understanding, the following introduces a method of an embodiment of the present invention from the aspect of interaction between a Web client and an application server.

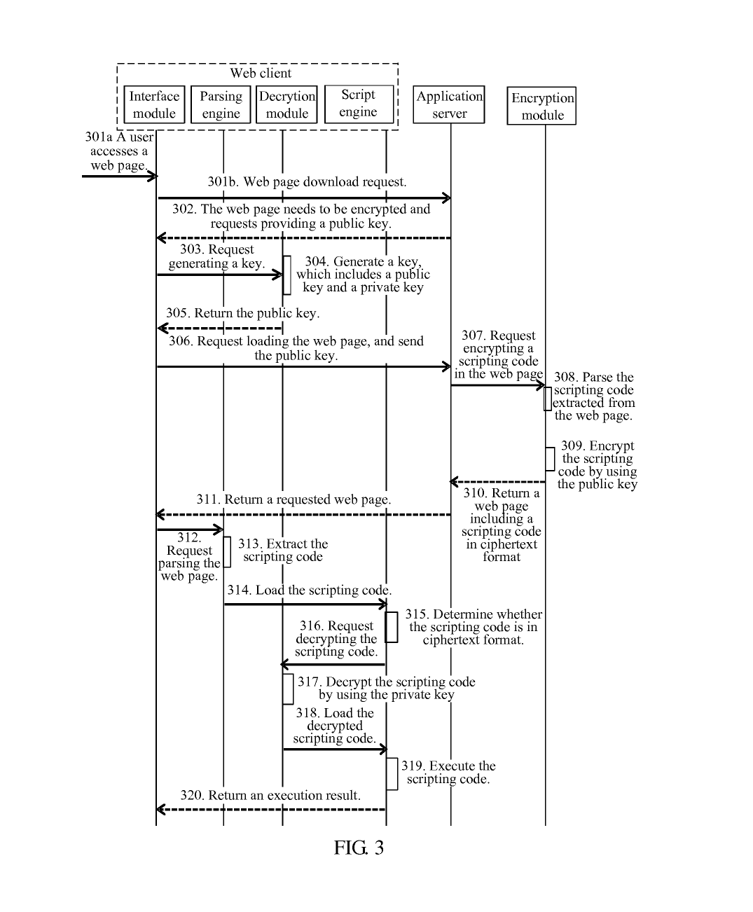

With reference to FIG. 4, it is another method for interaction between a Web client and an application server in an embodiment of the present invention. A symmetric encryption algorithm for encryption is used in the embodiment of the present invention. The method may include the following steps.

401a-401b. In response to an operation of a user accessing a web page, the Web client (for example, an interface module) sends a web page download request to a corresponding application server, to request loading the web page.

402. The application server determines whether the requested web page needs to be encrypted, and if it is determined that the requested web page needs to be encrypted, returns a response to the Web client, to request providing a key used for encryption.

403. After receiving the response, the interface module requests or calls a decryption module to generate a key.

404. The decryption module generates the key based on a key negotiation mechanism.

It should be noted that, the key is transmitted over the Internet, and the key is also managed by a generating party and a decrypting party, that is, the Web client, of the key.

405. The decryption module provides the key to the interface module.

406. The Web client (for example, the interface module) re-sends a web page download request to the application server, where the generated key is carried in the re-sent web page download request.

It should be noted that, the Web client re-sends the web page download request, and sends the key to the application server (securely communicating in https manner).

407. The application server requests or calls an encryption module to perform encryption on a scripting code in the requested web page.

408. The encryption module parses the requested web page, and extracts the scripting code in it.

409. The encryption module performs encryption on extracted scripting code by using the key.

410. The encryption module returns a web page including a scripting code in ciphertext format to the application server.

411. The application server returns the web page including the scripting code in ciphertext format to the Web client by using a web page download response.

412. The Web client (for example, the interface module) requests or calls a parsing engine to perform parsing on the web page.

413. The parsing engine parses the web page download response, and extracts the scripting code in the web page.

414. The parsing engine loads the scripting code in a script engine.

415. The script engine determines whether the scripting code loaded in the script engine is a scripting code in ciphertext format or a scripting code in plaintext format, and if the scripting code loaded in the script engine is a scripting code in ciphertext format, go to step 416; or if the scripting code loaded in the script engine is a scripting code in plaintext format, go to step 419.

416. The script engine requests or calls the decryption module to decrypt the scripting code in ciphertext format.

417. The decryption module performs decryption on the scripting code in ciphertext format by using the key generated in step 404, to obtain the scripting code in plaintext format.

418. The decryption module loads the scripting code in plaintext format after decryption to the script engine.

419. The script engine executes the scripting code in plaintext format loaded in it.

420. The script engine returns an execution result of the scripting code to the interface module.

It should be understood that, optionally, the interface module displays the execution result of the scripting code to a user, and may further, in response to a further operation of the user on the execution result of the scripting code, initiate another web page download request to the application server.

It can be seen from the above that, this embodiment has the following beneficial effects:

1) good confidentiality: A scripting language program code in a web page, after being transmitted to a Web client after being encrypted on an application server side, is directly loaded in a script engine in the Web client, and by using a decryption module inside the Web client, decryption is performed on the scripting language program code loaded in the script engine of the Web client, and a scripting language program code in plaintext format after decryption is loaded in the script engine for execution, during an entire transmission procedure from a server to the Web client, the scripting language program code in the web page is transmitted in ciphertext format, moreover, after a web page including the scripting language program code in ciphertext is downloaded to the Web client, because a decryption procedure is performed on the scripting language program code in ciphertext in the decryption module and the scripting language program code in plaintext format that is obtained by decryption and loaded in the script engine is executed in the script engine, in this way, the decryption procedure of the scripting language program code in the web page and an execution procedure of the scripting language program code in plaintext format after decryption are invisible to a Web client user, implementing the confidentiality of a scripting language program in the web page during a transmission procedure and an entire procedure of decryption and running inside the Web client, thereby better protecting a scripting language program code that reflects a service logic, and eliminating the security risks of a Web application; and

2) reducing the load of an application server: Because the scripting language program code in the web page actually implements concealing from the Web client user, some service logics running on the application server side may be ported to the scripting language program and run on the Web client; therefore, the load of the application server side can be effectively reduced.

An embodiment of the present invention further provides a relevant apparatus and system used for implementing the foregoing methods.

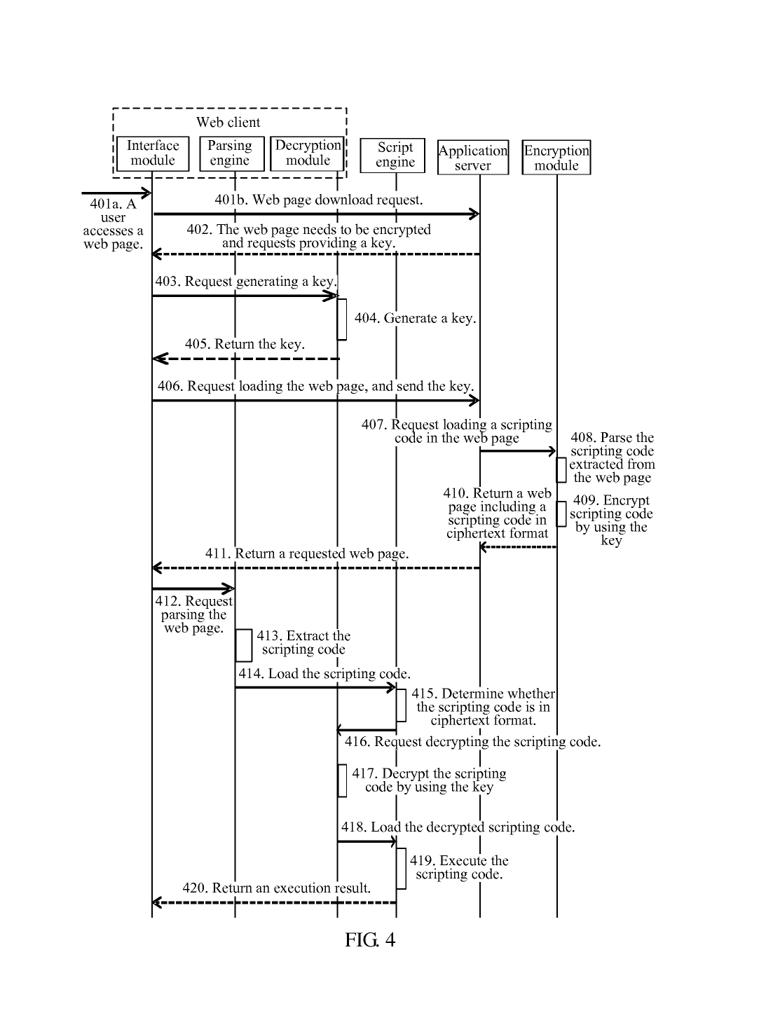

With reference to FIG. 5, an embodiment of the present invention provides a Web client 50, where the Web client 50, configured to interact with an application server, download a web page and parse the web page, and execute a scripting language program code in the web page, may include: an interface module 51, a parsing engine 52, a script engine 53, and a decryption module 54, where

the interface module 51 is configured to send a web page download request to a server; and receive a web page download response that corresponds to the web page download request and is returned by the server, where, the web page download response includes web page contents, where the web page contents include a scripting language program code;

the parsing engine 52 is configured to parse the web page download response, extract the scripting language program code from the web page contents included in the web page download response, and call a script engine for processing;

the script engine 53 is configured to determine, when the extracted scripting language program code is loaded in the script engine 53, whether the scripting language program code loaded in the script engine 53 is a scripting language program code in ciphertext format, and if the scripting language program code is in ciphertext format, call the decryption module 54 to perform decryption on the scripting language program code in ciphertext format, to obtain a scripting language program code in plaintext format, where, the scripting language program code in plaintext format is loaded in the script engine, and configured to execute the scripting language program code in plaintext format loaded in the script engine; and

the decryption module 54 is configured to perform decryption on the scripting language program code in ciphertext format, to obtain the scripting language program code in plaintext format.

In an implementation manner, if a symmetric encryption algorithm is used for encryption in the embodiment of the present invention, and the Web client actively generates a key, accordingly, the decryption module 54 is specifically configured to generate a key based on a predetermined first key negotiation mechanism, and perform, by using the generated key, decryption on the scripting language program code in ciphertext format, to obtain the scripting language program code in plaintext format.

Accordingly, the interface module 51 is specifically configured to send a web page download request carrying the generated key to the server; and receive a web page download response that corresponds to the web page download request and is returned by the server, where, the web page download response includes the web page contents, where the encrypted web page contents include the scripting language program code. It should be understood that, the scripting language program code herein is a scripting language program code in ciphertext format, or a scripting language program code in plaintext format; which depends on actual conditions.

Alternatively, in an implementation manner, if an asymmetric encryption algorithm is used for encryption in the embodiment of the present invention, and the Web client actively generates a key, accordingly, the decryption module 54 is specifically configured to generate a pair of keys based on a predetermined second key negotiation mechanism, where the keys include a public key and a private key; and perform, by using the generated private key, decryption on the scripting language program code in ciphertext format, to obtain the scripting language program code in plaintext format.

Accordingly, the interface module 51 is specifically configured to send a web page download request carrying the generated public key to the server; and receive a web page download response that corresponds to the web page download request and is returned by the server, where, the web page download response includes the web page contents, where the encrypted web page contents include the scripting language program code. It should be understood that, the scripting language program code herein is a scripting language program code in ciphertext format, or a scripting language program code in plaintext format; which depends on actual conditions.

Alternatively, in another implementation manner, if the server, after encrypting the scripting language program code by using a key, returns the web page download response, where the web page download response includes the web page contents (that is, a requested page) and a key (optionally, if the scripting language program code is not encrypted, the key is not included), where the web page contents include the scripting language program code in ciphertext format, to the Web client, and accordingly, the interface module 51 is specifically configured to send the web page download request to the server; and receive the web page download response that corresponds to the web page download request and is returned by the server, where, the web page download response includes the web page contents and the key, where the web page contents include the scripting language program code in ciphertext format.

Accordingly, the decryption module 54 is specifically configured to perform, by using the key or an Nth-generation key converted from the key, decryption on the scripting language program code in ciphertext format, to obtain the scripting language program code in plaintext format, where, the scripting code in plaintext format after decryption is loaded in the script engine, and N is larger than or equal to 2.

In another implementation manner, an asymmetric encryption algorithm or a symmetric encryption algorithm is used for encryption in the embodiment of the present invention, and the server actively requests a public key or a key.

In the case of the symmetric encryption algorithm, the interface module 51 is further configured to receive a first key negotiation request returned by the server after sending a first web page download request to the server, where the first key negotiation request is returned after the server receives the first web page download request; and specifically configured to send a web page download request carrying the key generated by the decryption module 54; and receive a returned web page download response that corresponds to the web page download request, where, the web page download response includes the web page contents, where the web page contents include the scripting language program code in ciphertext format, or the scripting language program code in plaintext format.

Accordingly, the decryption module 54 is specifically configured to generate a key based on the received first key negotiation request; and perform, by using the generated key, decryption on the scripting language program code in ciphertext format, to obtain the scripting language program code in plaintext format.

Alternatively, in the case of an asymmetric encryption algorithm, the interface module 51 is further configured to send a third web page download request to the server, and receive a third key negotiation request returned by the server, where the third key negotiation request is returned after the server receives the third web page download request; and specifically configured to send a web page download request carrying the public key generated by the decryption module; and receive a returned web page download response that corresponds to the web page download request, where, the web page download response includes the web page contents, where the web page contents include the scripting language program code in ciphertext format, or the scripting language program code in plaintext format.

Accordingly, the decryption module 54 is specifically configured to generate a pair of keys based on the received third key negotiation request, where the pair of keys includes a public key and a private key; and perform, by using the generated private key, decryption on the scripting language program code in ciphertext format, to obtain the scripting language program code in plaintext format.

It should be noted that, in the case that the asymmetric encryption algorithm is used, the decryption module 54 generates the pair of public key and private key. The public key is sent to the application server side for encryption, and the private key is reserved inside the Web client for decrypting an encrypted scripting language program. When a plaintext scripting language program code obtained from the decryption of the scripting language program is directly delivered to the script engine for execution, the entire working procedure is invisible to a Web client user.

It should be noted that, in the case that the symmetric encryption algorithm is used, the key is transmitted over the Internet, and the key is managed by a generating party and a decrypting party, that is, the Web client, of the key.

Preferably, in the embodiment of the present invention, the script engine 53 is specifically configured to determine whether the scripting language program code loaded in the script engine is a scripting language program code in ciphertext format, and if it is determined that the scripting language program code loaded in the script engine is in ciphertext format, call the decryption module to perform decryption on the scripting language program code in ciphertext format, to obtain the scripting language program code in plaintext format, and execute the scripting language program code in plaintext format loaded in the script engine 53; or if it is determined that the scripting language program code loaded in the script engine is in plaintext format, directly execute the scripting language program code in plaintext format loaded in the script engine 53.

Furthermore, the interface module 51 is further configured to display an execution result of the scripting language program code by the script engine 53.

It may be understood that, the Web client in this embodiment may be understood as a Web program running environment or a running container, for example, may be a Web browser, a Web Widget running container, a Web application running container, and so on, which is not limited by the embodiment of the present invention. The function of each function module of the Web client in this embodiment may be specifically implemented according to the method in the foregoing method embodiments, and for the specific implementation procedure, reference may be made to relevant description in the foregoing method embodiments, which is not described herein again.

It can be seen from the above that, the Web client provided by this embodiment has the following beneficial effects:

1) good confidentiality: A scripting language program code in a web page, after being transmitted to a Web client after being encrypted on an application server side, is directly loaded in a script engine in the Web client, and by using a decryption module inside the Web client, decryption is performed on the scripting language program code loaded in the script engine of the Web client, and a scripting language program code in plaintext format after decryption is loaded in the script engine for execution, during an entire transmission procedure from a server to the Web client, the scripting language program code in the web page is transmitted in ciphertext format, moreover, after a web page including the scripting language program code in ciphertext is downloaded to the Web client, because a decryption procedure is performed on the scripting language program code in ciphertext in the decryption module and the scripting language program code in plaintext format that is obtained by decryption and loaded in the script engine is executed in the script engine, in this way, the decryption procedure of the scripting language program code in the web page and an execution procedure of the scripting language program code in plaintext format after decryption are invisible to a Web client user, implementing the confidentiality of a scripting language program in the web page during a transmission procedure and an entire procedure of decryption and running inside the Web client, thereby better protecting a scripting language program code that reflects a service logic, and eliminating the security risks of a Web application; and

2) reducing the load of an application server: Because the scripting language program code in the web page actually implements concealing from the Web client user, some service logics running on the application server side may be ported to the scripting language program and run on the Web client; therefore, the load of the application server side can be effectively reduced.

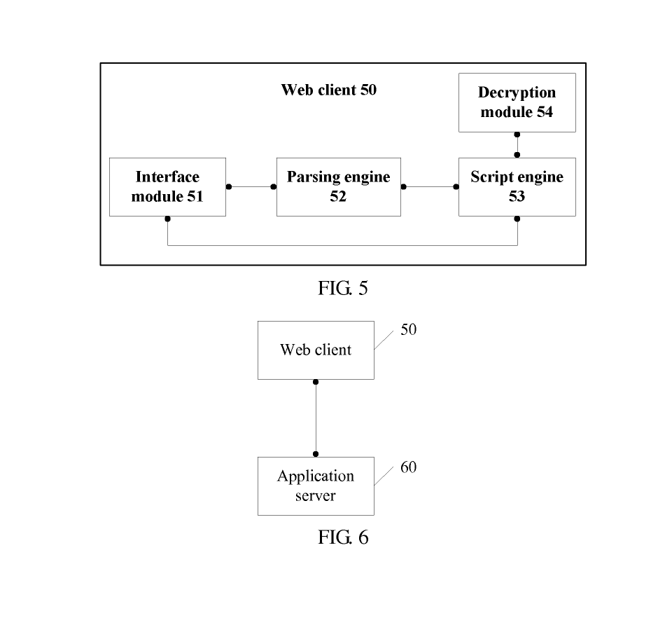

With reference to FIG. 6, an embodiment of the present invention further provides a Web system, where the Web system may include:

a Web client 50, configured to send a web page download request to a server; receive a web page download response returned by the server, where, the web page download response includes web page contents, and the web page contents include a scripting language program code in ciphertext format, or a scripting language program code in plaintext format; parse the web page download response, and extract a scripting language program code from the web page contents included in the web page download response; determine whether the extracted scripting language program code loaded in a script engine of the Web client is a scripting language program code in ciphertext format, and if the scripting language program code is in ciphertext format, call, through the script engine of the Web client, a decryption module of the Web client first to perform decryption on the scripting language program code in ciphertext format, to obtain the scripting language program code in plaintext format, where, the scripting language program code in plaintext format is loaded in the script engine of the Web client, and then the scripting language program code in plaintext format loaded in the script engine are executed by the script engine of the Web client; and

an application server 60, configured to receive the web page download request sent by the Web client 50, and return the web page download response to the Web client 50, where, the web page download response includes the web page contents, where the web page contents include the scripting language program code in ciphertext format, or the scripting language program code in plaintext format.

Preferably, the Web client 50 is further configured to: if it is determined that the extracted scripting language program code loaded in the script engine is in plaintext format, call the script engine to directly execute the scripting language program code loaded in the script engine.

The Web client 50 is further configured to: when requesting downloading a web page, generate a key, where the key includes a public key and a private key, and send the public key and the web page download request to the application server 60.

The application server 60 is further configured to: after receiving the web page download request, call an encryption module to extract the scripting language program code in the web page, and encrypt the scripting language program code by using the received public key.

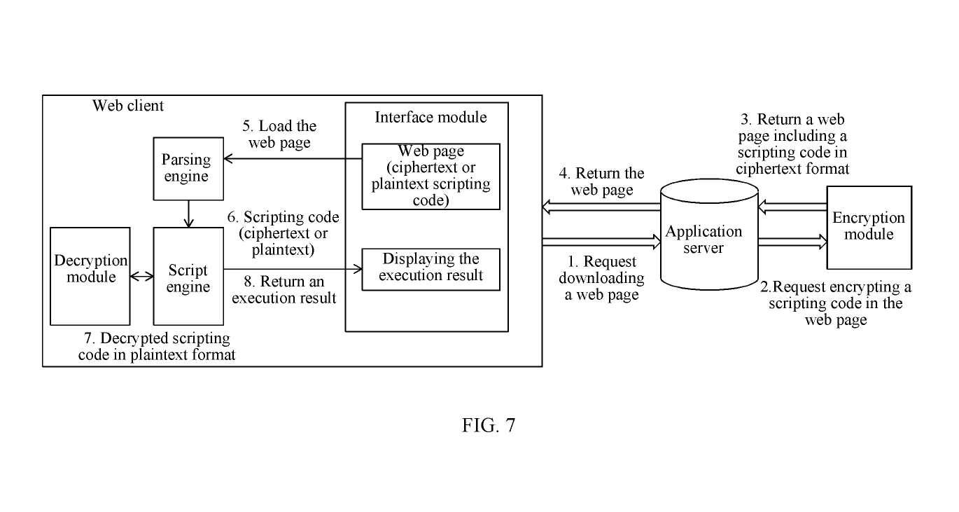

It should be noted that, as shown in FIG. 7, the application server provides some application services, and service contents are transmitted mainly in web pages. When a scripting language program code included in a web page needs to be encrypted, the application server may perform encryption on the scripting language program code, and returns web page contents carrying a scripting language program code in ciphertext format to the Web client, for example, the application server may call the encryption module of the application server or an external encryption module (as shown in FIG. 7) to parse the web page, extract a scripting language program in the web page, perform encryption on the scripting language program code included in the web page, and return the web page contents carrying the scripting language program code in ciphertext format to the Web client.

The encryption module is configured to parse the web page, extract the scripting language program code or a script file in the web page, and perform encryption on the extracted scripting language program code or the extracted script file by using a key. The key herein may include but is not limited to a key requested for the Web client to return (in the case of a symmetric encryption algorithm), or a public key requested for the Web client to return (in the case of an asymmetric encryption algorithm), or, a key negotiated in advance between the Web client and the application server.

The function of each composition part in the Web system in this embodiment as shown in FIG. 7 may be specifically implemented according to a function module in the foregoing apparatus embodiment, and be specifically implemented according to the method in the foregoing method embodiments. For a specific implementation procedure, reference may be made to relevant description in the foregoing method embodiments, which is not described herein again.

It should be noted that, the Web client and the application server may use an http request and response, or an https request and response to perform interaction.

It can be seen from the above that, the Web system provided by this embodiment has the following beneficial effects:

1) good confidentiality: A scripting language program code in a web page, after being transmitted to a Web client after being encrypted on an application server side, is directly loaded in a script engine in the Web client, and by using a decryption module inside the Web client, decryption is performed on the scripting language program code loaded in the script engine of the Web client, and a scripting language program code in plaintext format after decryption is loaded in the script engine for execution, during an entire transmission procedure from a server to the Web client, the scripting language program code in the web page is transmitted in ciphertext format, moreover, after a web page including the scripting language program code in ciphertext is downloaded to the Web client, because a decryption procedure is performed on the scripting language program code in ciphertext in the decryption module and the scripting language program code in plaintext format that is obtained by decryption and loaded in the script engine is executed in the script engine, in this way, the decryption procedure of the scripting language program code in the web page and an execution procedure of the scripting language program code in plaintext format after decryption are invisible to a Web client user, implementing the confidentiality of a scripting language program in the web page during a transmission procedure and an entire procedure of decryption and running inside the Web client, thereby better protecting a scripting language program code that reflects a service logic, and eliminating the security risks of a Web application; and

2) reducing the load of an application server: Because the scripting language program code in the web page actually implements concealing from the Web client user, some service logics running on the application server side may be ported to the scripting language program and run on the Web client; therefore, the load of the application server side can be effectively reduced.

It should be noted that, the expressions of first, second, third, and fourth used in the description of the foregoing embodiments are not intended to limit a sequence, but are only to facilitate distinguishing.

It should be noted that, for brevity, the foregoing method embodiments are represented as a series of action combinations. However, persons skilled in the art should acquire that the present invention is not limited to the order of the described actions, because according to the present invention, some steps may adopt another order or be performed simultaneously. Moreover, persons skilled in the art should acquire that the described embodiments all belong to exemplary embodiments, and the involved actions and modules are not necessarily required by the present invention.

In the foregoing embodiments, the description of each of the embodiments has respective focuses. For a part that is not described in detail in a certain embodiment, reference may be made to relevant descriptions in other embodiments.

Persons of ordinary skill in the art may understand that all or a part of the steps of the methods in the foregoing embodiments may be completed by a program instructing related hardware (such as a processor which is coupled with a memory). The program may be stored in a computer readable storage medium. The storage medium may include: a read-only memory, a random access memory, a magnetic disk, an optical disk, or the like.

The foregoing introduces virtualization processing methods and relevant apparatuses, and computer systems provided in the embodiments of the present invention in detail. The principle and implementation manner of the present invention are described herein by using specific examples. The description of the foregoing embodiments is merely used to help understand the method and core ideas of the present invention. In addition, persons of ordinary skill in the art may make variations and modifications to the present invention in terms of specific implementation manners and application scopes according to the ideas of the present invention. To sum up, the specification contents shall not be understood as a limit to the present invention.

What is claimed is:

1. A method for interaction between a Web client and a server, comprising:
sending a web page download request to the server;
receiving a web page download response that corresponds to the web page download request and is returned by the server, wherein the web page download response comprises web page contents, wherein the web page contents comprises a scripting language program code;
parsing the web page download response, and extracting the scripting language program code from the web page contents comprised in the web page download response; and
determining, when the extracted scripting language program code is loaded in a script engine of the Web client, whether the scripting language program code loaded in the script engine of the Web client is a scripting language program code in ciphertext format, and if the scripting language program code is in ciphertext format, calling a decryption module of the Web client first to perform decryption on the scripting language program code in ciphertext format, to obtain a scripting language program code in plaintext format, wherein the scripting language program code in plaintext format is loaded in the script engine of the Web client, and then execute, by the script engine, the scripting language program code in plaintext format loaded in the script engine.

2. The method according to claim 1, wherein
if a symmetric encryption algorithm is used for encryption, the method further comprises:
calling the decryption module to generate, based on a predetermined first key negotiation mechanism, a first key;
the sending a web page download request to the server comprises: sending a web page download request to the server, wherein the first key is carried in the web page download request; and
the calling a decryption module to perform decryption on the scripting language program code in ciphertext format, to obtain a scripting language program code in plaintext format comprises:
calling the decryption module to perform, by using the first key, decryption on the scripting language program code in ciphertext format, to obtain the scripting language program code in plaintext format.

3. The method according to claim 1, wherein
if an asymmetric encryption algorithm is used for encryption, the method further comprises:
calling the decryption module to generate, based on a predetermined second key negotiation mechanism, a pair of keys, wherein the keys comprises a second public key and a second private key;
the sending a web page download request to the server comprises: sending a web page download request to the server, wherein the second public key is carried in the web page download request; and
the calling a decryption module to perform decryption on the scripting language program code in ciphertext format, to obtain a scripting language program code in plaintext format comprises:
calling the decryption module to perform, by using the second private key, decryption on the scripting language program code in ciphertext format, to obtain the scripting language program code in plaintext format.

4. The method according to claim 1, wherein if the web page download response further carries a third key,
the calling a decryption module to perform decryption on the scripting language program code in ciphertext format, to obtain a scripting language program code in plaintext format comprises:
calling the decryption module to perform, by using the third key or an Nth-generation key converted from the third key, decryption on the scripting language program code in ciphertext format, to obtain the scripting language program code in plaintext format, wherein N is larger than or equal to 2.

5. The method according to claim 1, wherein if a symmetric encryption algorithm is used for encryption, before the step of sending the web page download request to the server, further comprising:
sending a first web page download request to the server;
receiving a first key negotiation request returned by the server, wherein the first key negotiation request is returned after the server receives the first web page download request; and
calling the decryption module to generate, based on the first key negotiation request, a fourth key;
accordingly, the sending a web page download request to the server comprises: sending a web page download request to the server, wherein the fourth key is carried in the web page download request; and
the calling a decryption module to perform decryption on the scripting language program code in ciphertext format, to obtain a scripting language program code in plaintext format comprises:
calling the decryption module to perform, by using the generated fourth key, decryption on the scripting language program code in ciphertext format, to obtain the scripting language program code in plaintext format.

6. The method according to claim 1, if an asymmetric encryption algorithm is used for encryption, before the step of sending a web page download request to the server, further comprising:
sending a third web page download request to the server;
receiving a third key negotiation request returned by the server, wherein the third key negotiation request is returned after the server receives the third web page download request; and
calling the decryption module to generate, based on the third key negotiation request, a pair of keys, wherein the pair of keys comprises a fifth public key and a fifth private key;
the sending a web page download request to the server comprises: sending a web page download request to the server, wherein the fifth public key is carried in the web page download request; and
the calling a decryption module to perform decryption on the scripting language program code in ciphertext format, to obtain a scripting language program code in plaintext format comprises:
calling the decryption module to perform, by using the generated fifth private key, decryption on the scripting language program code in ciphertext format, to obtain the scripting language program code in plaintext format.

7. The method according to claim 1, wherein the method further comprises:
executing directly, by the script engine, the scripting language program code loaded in the script engine, if it is determined that the scripting language program code loaded in the script engine of the Web client is in plaintext format.

8. The method according to claim 1, wherein the scripting language program code comprises Javascript, VBScript, or a flash script.

9. A Web client, comprising:
an interface module, configured to send a web page download request to a server; and receive a web page download response that corresponds to the web page download request and is returned by the server, wherein the web page download response comprises web page contents, wherein the web page contents comprise a scripting language program code;
a parsing engine, configured to parse the web page download response, and extract the scripting language program code from the web page contents comprised in the web page download response;
a script engine, configured to determine, when the extracted scripting language program code is loaded in the script engine, whether the scripting language program code loaded in the script engine is a scripting language program code in ciphertext format, and if the scripting language program code is in ciphertext format, call a decryption module to perform decryption on the scripting language program code in ciphertext format, to obtain a scripting language program code in plaintext format, wherein the scripting language program code in plaintext format is loaded in the script engine, and further configured to execute the scripting language program code in plaintext format loaded in the script engine; and
the decryption module, configured to perform decryption on the scripting language program code in ciphertext format, to obtain the scripting language program code in plaintext format.

10. The apparatus according to claim 9, wherein
the decryption module is specifically configured to generate a first key based on a predetermined first key negotiation mechanism, and perform, by using the generated first key, decryption on the scripting language program code in ciphertext format, to obtain the scripting language program code in plaintext format; and
the interface module is specifically configured to send a web page download request carrying the generated first key to the server; and receive the web page download response that corresponds to the web page download request and is returned by the server, wherein the web page download response comprises the web page contents, wherein the web page contents include the scripting language program code in ciphertext format, or the scripting language program code in plaintext format;

11. The apparatus according to claim 9, wherein
the decryption module is specifically configured to generate a pair of keys based on a predetermined second key negotiation mechanism, wherein the keys comprise a second public key and a second private key; and perform, by using the generated second private key, decryption on the scripting language program code in ciphertext format, to obtain the scripting language program code in plaintext format; and
the interface module is specifically configured to send a web page download request carrying the generated second public key to the server; and receive the web page download response that corresponds to the web page download request and is returned by the server, wherein the web page download response comprises the web page contents, wherein the web page contents include the scripting language program code in ciphertext format, or the scripting language program code in plaintext format.

12. The apparatus according to claim 9, wherein if the web page download response further carries a third key,
the decryption module is specifically configured to perform, by using the third key or an Nth-generation key converted from the third key, decryption on the scripting language program code in ciphertext format, to obtain the scripting language program code in plaintext format, wherein the scripting code in plaintext format is loaded in the script engine, and N is larger than or equal to 2.

13. The apparatus according to claim 9, wherein
the interface module is further configured to send a first web page download request to the server, and receive a first key negotiation request returned by the server, wherein the first key negotiation request is returned after the server receives the first web page download request; and specifically configured to send a web page download request carrying a fourth key generated by the decryption module; and receive a returned web page download response that corresponds to the web page download request, wherein the web page download response comprises the web page contents, wherein the web page contents comprise the scripting language program code in ciphertext format, or the scripting language program code in plaintext format; and
the decryption module is specifically configured to generate the fourth key based on the received first key negotiation request; and perform, by using the generated fourth key, decryption on the scripting language program code in ciphertext format, to obtain the scripting language program code in plaintext format.

14. The apparatus according to claim 9, wherein
the interface module is further configured to send a third web page download request to the server, and receive a third key negotiation request returned by the server, wherein the third key negotiation request is returned after the server receives the third web page download request; and specifically configured to send a web page download request carrying a fifth public key generated by the decryption module; and receive a returned web page download response that corresponds to the web page download request, wherein the web page download response comprises the web page contents, wherein the web page contents comprise the scripting language program code in ciphertext format, or the scripting language program code in plaintext format; and
the decryption module is specifically configured to generate a pair of keys based on the received third key negotiation request, wherein the pair of keys comprises the fifth public key and a fifth private key; and perform, by using the generated fifth private key, decryption on the scripting language program code in ciphertext format, to obtain the scripting language program code in plaintext format.

15. The apparatus according to claim 9, wherein the script engine is further configured to: execute directly the scripting language program code loaded in the script engine, if it is determined that the scripting language program code loaded in the script engine is in plaintext format.

16. A Web system, comprising:
an application server; and
a Web client, wherein the application server is configured to receive a web page download request sent from the Web client, and return a corresponding web page download response to the Web client, wherein the web page download response comprises web page contents, wherein the web page contents comprise a scripting language program code in ciphertext format, or, a scripting language program code in plaintext format; and
the Web client is configured to send a web page download request to the application server, receive a web page download response that corresponds to the web page download request and is returned by the application server, wherein the web page download response comprises web page contents, wherein the web page contents comprises a scripting language program code; parse the web page download response, and extract the scripting language program code from the web page contents comprised in the web page download response; and determine, when the extracted scripting language program code is loaded in a script engine of the Web client, whether the scripting language program code loaded in the script engine of the Web client is a scripting language program code in ciphertext format, and if the scripting language program code is in ciphertext format, call a decryption module of the Web client first to perform decryption on the scripting language program code in ciphertext format, to obtain a scripting language program code in plaintext format, wherein the scripting language program code in plaintext format is loaded in the script engine of the Web client, and then execute, by the script engine, the scripting language program code in plaintext format loaded in the script engine.

17. A non-transitory computer readable medium having computer executable instructions for performing a method for interaction between a Web client and a server, comprising:
sending a web page download request to the server;
receiving a web page download response that corresponds to the web page download request and is returned by the server, wherein the web page download response comprises web page contents, wherein the web page contents comprises a scripting language program code;
parsing the web page download response, and extracting the scripting language program code from the web page contents comprised in the web page download response; and
determining, when the extracted scripting language program code is loaded in a script engine of the Web client, whether the scripting language program code loaded in the script engine of the Web client is a scripting language program code in ciphertext format, and if the scripting language program code is in ciphertext format, calling a decryption module of the Web client first to perform decryption on the scripting language program code in ciphertext format, to obtain a scripting language program code in plaintext format, wherein the scripting language program code in plaintext format is loaded in the script engine of the Web client, and then execute, by the script engine, the scripting language program code in plaintext format loaded in the script engine.
